(19) United States
(12) Patent Application Publication
(10) Pub. No.: US 2022/0121670 A1
(43) Pub. Date: Apr. 21, 2022

(54) METHODS AND SYSTEMS FOR ELEMENT ORGANIZATION AND RANKING

(71) Applicant: Net Consensus, Inc., Los Angeles, CA (US)

(72) Inventors: Thomas Wolfley, Laguna Niguel, CA (US); Drew Berra, Pasadena, CA (US)

(21) Appl. No.: 17/075,635

(22) Filed: Oct. 20, 2020

(51) Int. Cl. G06F 16/2457

(52) U.S. Cl. CPC G06F 16/24578

(57) ABSTRACT

Methods, systems, and devices for accurate ratings of elements are provided. Conceptual groupings are provided with elements. The elements are rated according to system-participant votes, and those system-participant votes are scored according to their accuracy. The weight of the system-participant votes is modified according to the system-participant's accuracy in voting.

### TECHNICAL FIELD

Various embodiments of the present disclosure generally relate to a systems and methods relating to the creation of groups, and the predictive ranking of elements within those groups.

### BACKGROUND

A number of web sites offer various forms of user rating functions. For example, web sites attempt to collect user ratings for items listed. User ratings that are collected online do not often reflect the actual value of a rated element because of inaccuracies that are present in user rating systems. It is difficult to keep user rating standards consistent, homogeneous, and rigorous.

As a simple example, take a website that provides book ratings on scientific topics. Person A (who is new to a subject) may rate a book on that subject a 5 out of 5 thinking that the book is great. And Person B—who is an expert in the subject—may give that very same book a rating of 2 out of 5 recognizing that it is not a good book. This book may have many errors that any knowledgeable person in the field would recognize but a new reader, looking at ratings alone, would have no way to distinguish between the rating of Person B and Person A. A purchaser would view the book as an average of two ratings, i.e., a 3.5 star book. Further, a second book that is rated by two other knowledgeable people may end up with a rating of 3 stars. In this example, the second book is better than the first book but, because of the faulty ranking system, the first book would have a higher rating and ranked higher. This would demonstrate that the first book was superior when, in fact, it is not good at all.

This type of simplistic ranking is further employed by databasing systems. For instance, database systems will count how many times an element is present, but will not identify the quality or accuracy of each element. This may result in over-reporting of elements that provide little value.

Other, even more simplistic systems, tally votes to rank quality. For instance, several social media platforms rank postings by tallying website hits or user likes, and ranking content based on how many website hits, or likes, content received. These systems do not take into account the accuracy of the voting.

As such, there is need for a system that takes the accuracy of the input into account when providing scoring and ranking.

### SUMMARY

This document relates to methods, systems, and devices for predictive rankings of elements of a group. The subject matter described in this document may be implemented in a variety of ways to provide one or more of the following features. For instance, the following systems and methods can be implemented in databasing systems, or any type of data structure, for organization of elements in a more sophisticated manner. The systems and methods can be implemented on any type of computing device, such as a personal computer, mobile device, or on Internet server systems. The systems and methods can be implemented through a web interface over the Internet.

In an aspect, methods are provided for receiving a request to create a system, the system having a topic that relates to a certain conceptual grouping, receiving a request to add one or more participants to the system, receiving a request to add one or more elements to the system from the one or more participants, the one or more elements each having a corresponding rating, receiving a vote on the one or more elements from the one or more participants, determining the accuracy of the received vote from the one or more participants, updating a voting strength of the participant using the determined accuracy of the vote, and updating the rating of the element using the accuracy of the vote.

In yet another aspect, the system has a sub-system and the sub-system has a second set of one or more elements. In yet another aspect, a table of participants is created, the table ranking all of the one or more participants of the system according to a voting score, the voting score being calculated according to the accuracy of votes provided by each participant. In yet another aspect, the request to add one or more participants is restricted according to the voting score of the participant. In yet another aspect, the voting score is calculated on a predetermined basis. In yet another aspect, a request to add one or more participants is provided only after sending an invitation to be added to the system. In yet another aspect, an average rate of insertion of elements is calculated. In yet another aspect, the vote is a score of either 0 or 10. In yet another aspect, the rating of the element is further determined according to a predetermined set of votes.

As will be realized, embodiments of the disclosure are capable of modifications in various aspects, all without departing from the scope of the present disclosure. Accordingly, the drawings and detailed description are to be regarded as illustrative in nature and not restrictive.

### BRIEF DESCRIPTION OF THE DRAWINGS

FIG. 1 illustrates a block diagram illustrating components that can be included in an accurate rating system in accordance with various embodiments of the present disclosure;

FIG. 2 illustrates a flow chart illustrating a set of operations for an accurate rating system in accordance with some embodiments of the present disclosure;

FIG. 3 illustrates a flow chart illustrating a set of operations for an accurate rating system in accordance with some embodiments of the present disclosure;

FIG. 4 illustrates a table illustrating voting strength of participants of a system for an accurate rating system in accordance with some embodiments of the present disclosure;

FIG. 5 illustrates a flowchart of the creation of a system.

While embodiments of the present disclosure are amenable to various modifications and alternative forms, specific embodiments have been shown by way of example in the drawings and are described in detail below. The intention, however, is not to limit the disclosure to the particular embodiments described. On the contrary, the disclosure is intended to cover all modifications, equivalents, and alternatives falling within the scope of the disclosure as defined by the appended claims.

### DETAILED DESCRIPTION

The present disclosure relates the predictive ranking of elements within a system. Embodiments of the present disclosure generally relate to a ranking and rating system for elements of a “system,” which can be a grouping of elements. In some embodiments, the system referred to herein is any type of grouping or category of elements, and the elements are any type of data which can be structured in an ordered form. The element's rating or ranking can be manipulated via user scores. As described by the present disclosure, elements within a database can be organized via group, where each element can have a ranking or rating. Further, the ranking or rating is itself based on the ranking or rating of the inputs that go toward ranking or rating the element itself. Further, each element can itself be a group, and have a set of sub-elements, each scored. Prior art systems failed to provide a quality ranking of elements within their organized data structures, and they failed to provide a rating or ranking measure for any inputs they used to organize their elements. These prior art systems further did not provide a mechanism by which elements could provided with sub-elements, and those sub-elements could be provided with sub-elements, etc., where each element and sub-element has a quality ranking or rating, where the mechanism to provide the quality ranking or rating itself was given a quality ranking or rating. With this disclosure, not only are elements better organized, they are most easily retrievable, because a user could access higher quality elements, because the inputs to the ranking and rating of elements have been themselves ranked and rated via the mechanisms described herein.

Modern online market place and online chat forums provide users the platform to share their feedback of a product or opinions on a topic. As an example, the present disclosure provides embodiments where predictive ranking is applied to postings on Internet message boards. It should be understood, however, that the disclosures provided herein can be used to provide ratings, or can be provided on any type of data structure where the elements within the data structure can be subjectively scored. The disclosure can be implemented as system, on a content delivery network or other kind of server or computer system.

Using the embodiments of the present disclosure, users can utilize the systems to share content and opinions. Other users can provide ratings or votings on those users' content, and the quality of those other users' ratings or votings can be taken into consideration when rating the user's content. Users that consistently provide accurate votes, or consistently provide quality content that receives high votes, can be placed on leader boards. In this manner, users that consistently provide quality voting and content in particular subjects can receive recognition. For example, a user that provides quality content within a grouping of “Java,” for example, can be immediately recognized by the community as a person having a high level of proficiency in the subject due to their high ranking on the leader board.

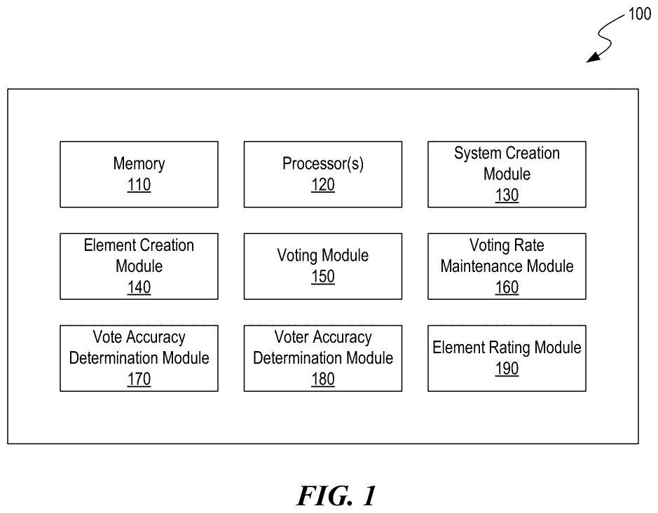

FIG. 1 is a block diagram illustrating components of a predictive rating system in accordance with various embodiments of the present disclosure. The accurate rating system 100 can include memory 110, one or more processors 120, system creation module 130, element creation module 140, voting module 150, voting rate maintenance module 160, vote accuracy determination module 170, voter accuracy determination module 180, and element rating module 190.

It should be understood that these modules are exemplary and are not intended to be limiting. Other embodiments of the present disclosure may include some, all, or none of these modules and components along with other modules, applications, and/or components. Still yet, some embodiments may incorporate two or more of these modules into a single module and/or associate a portion of the functionality of one or more of these modules with a different module. For example, in one embodiment, the functionality associated with system creation module 130 and element creation module 140 can be incorporated into a single rating system creation module. As another example, in one embodiment, the voting rate maintenance module 160 can be separated into a participant voting rate determination module for determining the voting rate of participants of the system, an element voting rate determination module for determining the average number of votes per element of the system, and a participation information module to encourage voters to cast more votes or discourage voters from casting more votes.

Memory 110 can be any device, mechanism, or populated data structure used for storing information. In accordance with some embodiments of the present disclosure, memory 110 can encompass any type of, but is not limited to, volatile memory, nonvolatile memory, and can store data in any type of data structure, or database. It should be understood that a data structure, as used herein refers to data that is provided in an organized manner. Memory 110 may be used to store instructions for running one or more applications or modules on processor(s) 120. For example, memory 110 could be used in one or more embodiments to house all or some of the instructions needed to execute the functionality of system creation module 130, element creation module 140, voting module 150, voting rate maintenance module 160, vote accuracy determination module 170, voter accuracy determination module 180 and element rating module 190.

System creation module 130 is configured to create a system. For example, the system described herein refers to a data structure which can provide for an ordered set of elements. The system creation module 130 can create different kinds of systems. For example, a grouping of a particular topic can be a system. As can a shopping website, standalone application, or database.

The system creation module 130 creates a unique system using one of several different mechanisms. In some embodiments, a system can be created by a system administrator, or can be provided as a grouping by a participant. The system can be pre-set, or can be made to evolve with participant-created content.

In an embodiment, the system creation module 130 creates a system with several participants. For instance, the system can be implemented as a website with ordered, participant-created, elements. The list of participants can be pre-set, or participants can join onto the system via sign-up. The number of participants can change over time as participants join or leave the system.

Participants can be human, or computer programs, capable of contributing to the ranking of elements within that system. Once a system is created, participants can join or leave the system. In some embodiments, a participant of the system can create another system and be a participant of that system. In other words, a system can comprise any number of sub-systems. For instance, a participant can create a system coined as “cat” within an “animal” related system. Further still, a participant can create a system coined as “food” within system “cat” within system “animal.” Each of the systems can each have ranked elements. For instance, an element within “animal” system may have an element that describes dogs as an intelligent animal. The “cat” system may have an element that describes cat tendencies. And, the “food” system may have an element that describes cat food brands. These examples are provided merely as exemplary, and it should be understood that any type of system and elements can be utilized.

Participants can join created systems. In some embodiments, after the sole participant creates a system, other participants can join the system and can then subsequently leave the system.

In some embodiments, participants can freely join or leave a system. For example, human participants may freely join the “cat” system. In some embodiments, participants may need to get approval of the system administrator to join or leave a system. For example, human participants may be restricted to join the “cat” system via invite, or via approved request.

In other embodiments, there can be other mechanisms—such as an algorithmic determination of participant's voting accuracy—to approve the joining or leaving of a participant. For instance, a human participant who votes regularly in a “Physics” system, may be invited algorithmically to join a system “Physics Experts” due to their accurate voting of elements within the “Physics” system.

Element creation module 140 creates and adds elements to the system. Elements can be created and added to a system via system administrator or by participants of the system. In some embodiments, elements can be created and added to a system at a specified average rate of insertion (r_i). Elements can also be created and added to a system at any random rate which can vary over time.

Elements can be a post, a product, or a service, depending on the type of system. For example, in a shopping web site/app system, elements can be products; in an opinion group system, elements can be posts; in a website/app offering services, elements can be services. For instance, in the context of a message board, an element within system “cats” can be a user-created opinion on their cat's personality, along with pictures of their cat. In the context of a shopping website, a certain dress can be an element within system “women's summer clothing.”

Voting module 150 facilitates participant voting on elements of a system. In some embodiments, the voting module 150 allows all the participants of a system to vote freely on any element of the system. In some embodiments, the voting module 150 allows only a subset of the participants to vote on any element of the system. The participants can be restricted, based on vote quality, or participation in certain systems. In some embodiments, the voting module 150 allows a specific subset of the participants to vote on a specific element of the system.

As an example, for a created system “Science,” users can vote on a user-submitted element “Scientific evidence that the world is flat.” Some users votes may be restricted, or the power of their score degraded significantly if, for instance, they positively voted on a previous element “Vaccines are a hoax.” In an embodiment, user's voting power is restricted in a system specific manner because some users may have faulty opinions in the “Science” system, but have strong accurate votes in the “Comedy” system.

As another example, for a system “Science Experts,” only those with a positive voting record in “Science” will be allowed to cast votes. As another example, some users will be able to vote in certain restricted systems such as “Science Experts” if they are also participants in other restricted system such as “Physics PhDs.”

Voting module 150 allows participant voting of a single (or multiple) elements in various ways. For example, a participant of a system can vote on an element by clicking on a button, or by rating the element using a number (e.g., by picking a number between 0 to 10). In other embodiments, participant votes are internally scored by applying a certain number to their vote (e.g., either a 0 or a 10).

In some embodiments, a participant of a system can vote on an element of a system by rating it using a number 0 or 10. In some embodiments, a participant of a system can vote on an element of a system by clicking a button that increases a tally, or by clicking a separate button that decreases the tally. In some embodiments, a user may vote an element as a positive or a negative. The voting module 150 can also take these two alternative buttons, and internally score them as a 0 or a 10. A weighted average of scores can be maintained via any internal data structure on memory.

The below algorithm demonstrates an exemplary embodiment of vote collection.

```
VOTE_CHOICES = [0, 10]
def create Vote(cls, user, target, subQuest, timeDeltaInHours, vote):
  if vote not in VOTE_CHOICES:
    raise UpQuestClientError(message=“Vote is not one of the vote choices.
Down(0) or Up(10).”, status=406)
  if user.getNumVotesInSubQusetForTimePeriod(subQuestId=subQuest.id) >=
subQuest.maxVotesPerDay:
    raise UpQuestClientError(
      message=“You have reached the maximum number of votes for a day in ”
+ subQuest.displayName + “.”,
      status=406
    )
  timeToBeEvaluated = datetime.datetime.now(timezone.utc) +
timedelta(hours=timeDeltaInHours)
  vote = cls(
    user=user,
    target=target,
    subQuest=subQuest,
    previousScore=target.score,
    timeToBeEvaluated=timeToBeEvaluated,
    vote=vote
  )
  vote.save( )
```

Voting rate maintenance module 160 controls the rate of voting in a system to maintain the accuracy of the rating and ranking of elements. The voting rate determination module 160 determines the voting rate of participants of the system as average number of votes per unit of time and the average number of votes per element of the system.

The voting rate determination module 160 can be employed to encourage participants of the system to cast votes. For instance, if the voting rate determination module 160 determines that the average number of votes per unit of time for an element is not close to F*r_i for a specified factor F (where r_i is the rate of insertion of elements), then voting rate determination module 160 encourages the participants of the system to cast further votes. Similarly, if the voting rate determination module 160 determines that the average number of votes per unit of time is close to or above F*r_i, then voting rate determination module 160 can discourage the participants of the system from further voting.

The below algorithm illustrates an exemplary embodiment where users are encouraged to cast enough votes within a day.

```
  def dailyVoteEncouragement( ):
  currentDateTimePst = datetime.now(tz=pytz.timezone(“US/Pacific”))
  workingDateTimePst = currentDateTimePst − timedelta(days=1)
  startOfWorkingTimeFramePst = datetime(
    year=workingDateTimePst.year,
    month=workingDateTimePst.month,
    day=workingDateTimePst.day,
    hour=0,
    minute=0,
    second=0,
    microsecond=0,
    tzinfo=workingDateTimePst.tzinfo)
  endOfWorkingTimeFramePst = datetime(
    year=workingDateTimePst.year,
    month=workingDateTimePst.month,
    day=workingDateTimePst.day,
    hour=23,
    minute=59,
    second=59,
    microsecond=999999,
    tzinfo=workingDateTimePst.tzinfo)
  startOfWorkingTimeFrameUtc =
startOfWorkingTimeFramePst.astimezone(tz=timezone.utc)
  endOfWorkingTimeFrameUtc =
endOfWorkingTimeFramePst.astimezone(tz=timezone.utc)
  for subQuest in SubQuest.getSubQuests( ):
    editedLeaderboardEntries = { }
    leaderboardEntriesForSubquest = list(
      LeaderboardEntry.objects.filter(
        subQuest_id=subQuest.id
      ).only(
        ‘id’,
        ‘user_id’,
        ‘subQuest_id’,
        ‘score’,
        ‘lastActionInSubQuestTimeStamp’,))
    numUsersInSubQuest = len(leaderboardEntriesForSubquest)
    for leaderboardScore in leaderboardEntriesForSubquest:
      numPostVotesInTimePeriod = PostVote.objects.filter(
        subQuest_id=leaderboardScore.subQuest_id,
        user_id=leaderboardScore.user_id,
        createdTimeStamp_gte=startOfWorkingTimeFrameUtc,
        createdTimeStamp_lte=endOfWorkingTimeFrameUtc,
      ).count( )
      numCommentVotesInTimePeriod = CommentVote.objects.filter(
        subQuest_id=leaderboardScore.subQuest_id,
        user_id=leaderboardScore.user_id,
        createdTimeStamp_gte=startOfWorkingTimeFrameUtc,
        createdTimeStamp_lte=endOfWorkingTimeFrameUtc,
      ).count( )
numMissingVotes = SubQuest.MIN_VOTES_PER_DAY −
(numPostVotesInTimePeriod + numCommentVotesInTimePeriod)
      if numMissingVotes > 0:
        userScoreDelta = −numMissingVotes
        if leaderboardScore.id in editedLeaderboardEntries:
          leaderboardScore = editedLeaderboardEntries[leaderboardScore.id]
        leaderboardScore.score = leaderboardScore.score + userScoreDelta
        editedLeaderboardEntries[leaderboardScore.id] = leaderboardScore
        if numUsersInSubQuest > 1:
          otherUserScoreDelta = numMissingVotes / (numUsersInSubQuest −
1)
          for otherLeaderboardScore in leaderboardEntriesForSubquest:
            if otherLeaderboardScore.id == leaderboardScore.id:
              continue
            if otherLeaderboardScore.id in editedLeaderboardEntries:
              otherLeaderboardScore =
editedLeaderboardEntries[otherLeaderboardScore.id]
            otherLeaderboardScore.score = otherLeaderboardScore.score +
otherUserScoreDelta
            editedLeaderboardEntries[otherLeaderboardScore.id] =
otherLeaderboardScore
      else:
        if leaderboardScore.id in editedLeaderboardEntries:
          leaderboardScore = editedLeaderboardEntries[leaderboardScore.id]
        editedLeaderboardEntries[leaderboardScore.id] = leaderboardScore
    for key, value in editedLeaderboardEntries.items( ):
      updatedLeaderboardEntries.append(value)
  LeaderboardEntry.objects.bulk_update(updatedLeaderboardEntries, [‘score’, ],
batch_size=5000)
```

The following exemplary algorithm demonstrates the discouragement of casting too many votes.

```
VOTE_CHOICES = [0, 10]
def createVote(cls, user, target, subQuest, timeDeltaInHours, vote):
  if vote not in VOTE_CHOICES:
    raise UpQuestClientError(message=“Vote is not one of the vote choices.
Down(0) or Up(10).”, status=406)
  if user.getNumVotesInSubQusetForTimePeriod(subQuestId=subQuest.id) >=
subQuest.maxVotesPerDay:
    raise UpQuestClientError(
      message=“You have reached the maximum number of votes for a day in ”
+ subQuest.displayName + “.”,
      status=406 )
  timeToBeEvaluated = datetime.datetime.now(timezone.utc) +
timedelta(hours=timeDeltaInHours)
  vote = cls(
    user=user,
    target=target,
    subQuest=subQuest,
    previousScore=target.score,
    timeToBeEvaluated=timeToBeEvaluated,
    vote=vote )
    vote.save( )
```

Vote accuracy determination module 170 is configured to determine the accuracy of a vote cast on an element of a system by a participant of the system. The vote accuracy determination module 170 can calculate the accuracy of votes on a discrete or continuous basis. For instance, the vote accuracy determination module 170 can determine the accuracy of a vote as soon as the vote is cast. The vote accuracy determination module 170 can also determine the accuracy of all the votes cast in a day in a batch mode at a specific time once per day.

In an embodiment, for each vote v on an element, there was a previous score s_p, and there is a subsequent score s_n. The change in score is s_n−s_p=ds. The system determines the accuracy of the voter by f(v, s_p, s_n)=a. The calculation of a can be done at a certain time of day, once a day, or at any preset interval.

In an embodiment, votes that have existed for 24 hours or longer can be determined to be incorrect (or correct) based on their original directional score, i.e., 0 or 10, or whether ds>0 or ds<0. Incorrect votes can be discarded by the system, and not counted.

Provided below is an exemplary algorithm for determining voter accuracy.

```
def calculateUserVoteAccuracy( ):
  currentTime = datetime.datetime.now(timezone.utc)
  subQuests = SubQuest.getSubQuests( )
  for subquest in subQuests:
    postVotes =
PostVote.getUnscoredVotesForSubQuest(subQuest=subquest,
currentTime=currentTime)
    commentVotes =
CommentVote.getUnscoredVotesForSubQuest(subQuest=subquest,
currentTime=currentTime)
    voteList = sorted(chain(postVotes, commentVotes), key=lambda vote:
vote.createdTimeStamp)
    subQuestLeaderboardEntries = list(
      LeaderboardEntry.objects.filter(
        subQuest=subquest))
    numUsersInSubQuest = len(subQuestLeaderboardEntries)
    subQuestLeaderboardEntriesByUid = { }
    for leaderboardEntry in subQuestLeaderboardEntries:
      subQuestLeaderboardEntriesByUid[leaderboardEntry.user_id] =
leaderboardEntry
    updatedPostVotes = [ ]
    updatedCommentVotes = [ ]
    numTimesUsersIncorrect = 0
    numTimesUsersCorrect = 0
    subOuestScoreDelta = 0
    if numUsersInSubQuest > 1:
      subQuestScoreDelta = 1 / (numUsersInSubQuest − 1)
    for voteObj in voteList:
      previousScore = voteObj.previousScore
      timeFrame = voteObj.timeToBeEvaluated
      if isinstance(voteObj, PostVote):
        userVotesInfo = PostVote.objects.filter(
          user_id=voteObj.user_id,
          post_id=voteObj.post_id,
          createdTimeStamp_lte=timeFrame,
          createdTimeStamp_gte=voteObj.createdTimeStamp
        ).aggregate(
          vote Sum=Sum (‘vote’, output_field=FloatField( )),
          numVotes=Count(‘id’)
        )
        numVotesOnObject = voteObj.post.numVotes
        subsequentScore = voteObj.post.score
      else:
        userVotesInfo = CommentVote.objects.filter(
          user_id=voteObj.user_id,
          comment_id=voteObj.comment_id,
          createdTimeStamp_lte=timeFrame,
          createdTimeStamp_gte=voteObj.createdTimeStamp
        ).aggregate(
          voteSum=Sum(‘vote’, output_field=FloatField( )),
          numVotes=Count(‘id’)
        )
        numVotesOnObject = voteObj.comment.numVotes
        subsequentScore = voteObj.comment.score
      unAveragedSubsequentScore = subsequentScore *
numVotesOnObject
      adjustedSubsequentScore = (unAveragedSubsequentScore −
userVotesInfo[“voteSum”]) / (
            numVotesOnObject − userVotesInfo[“numVotes”])
      if (voteObj.vote == 10 and adjustedSubsequentScore >
previousScore) or (
          voteObj.vote == 0 and adjustedSubsequentScore <
previousScore):
        wasCorrect = True
        numTimesUsersCorrect += 1
        voterScoreDelta = 1 + subQuestScoreDelta
      elif (voteObj.vote == 10 and adjustedSubsequentScore <
previousScore) or (
          voteObj.vote == 0 and adjustedSubsequentScore >
previousScore):
        wasCorrect = False
        numTimesUsersIncorrect += 1
        voterScoreDelta = −(1 + subQuestScoreDelta)
      else:
        wasCorrect = False
        voterScoreDelta = 0
      voterLeaderboardEntry =
subQuestLeaderboardEntriesByUid[voteObj.user_id]
      voterLeaderboardEntry.score = voterLeaderboardEntry.score +
voterScoreDelta
      subQuestLeaderboardEntriesByUid[voteObj.user_id] =
voterLeaderboardEntry
      voteObj.wasUserScoreCalculated = True
      voteObj.wasUserPredictionResult = wasCorrect
      voteObj.evaluatedTimeStamp = currentTime
      voteObj.subsequentScore = adjustedSubsequentScore
      if isinstance(voteObj, PostVote):
        updatedPostVotes.append(voteObj)
      else:
        updatedCommentVotes.append(voteObj)
    incorrectNonVoterScoreDelta = subQuestScoreDelta
    correctNonVoterScoreDelta = −subQuestScoreDelta
    scoreDelta = (numTimesUsersCorrect * correctNonVoterScoreDelta) +
(
          numTimesUsersIncorrect * incorrectNonVoterScoreDelta)
    for key in subQuestLeaderboardEntriesByUid:
      nonVoterLeaderboardEntry =
subQuestLeaderboardEntriesByUid[key]
      nonVoterLeaderboardEntry.score =
nonVoterLeaderboardEntry.score + scoreDelta
      subQuestLeaderboardEntriesByUid[key] =
nonVoterLeaderboardEntry
LeaderboardEntry.objects.bulk_update(subQuestLeaderboardEntriesByUid.
values( ), [‘score’, ], batch_size=5000)
    voteObjFieldsToUpdate = [
      ‘wasUserScoreCalculated’,
      ‘wasUserPredictionResult’,
      ‘evaluatedTimeStamp’,
      ‘subsequentScore’
    ]
    PostVote.objects.bulk_update(updatedPostVotes,
voteObjFieldsToUpdate, batch_size=5000)
    CommentVote.objects.bulk_update(updatedCommentVotes,
voteObjFieldsToUpdate, batch_size=5000)
```

Voter accuracy determination module 180 is configured to determine the voting accuracy of participants of the system. In some embodiments, the voter accuracy determination module 180 determines the voting accuracy of a participant as soon as the participant casts a new vote on an element of the system. The voter accuracy determination module 180 can also determine the voting accuracy of all the participants of a system in a batch mode at predetermined intervals (e.g., once a day at a specific time). It should be understood that the voter accuracy determination module 180 can determine accuracy on a system specific (or multiple system) manner.

In some embodiments, the voter accuracy determination module 180 also provides an incentive mechanism that rewards participants of the system if they have greater voting accuracy. The voter accuracy determination module 180 provides a voting power adjustment function I_m=f( . . . ) that rewards participants for having greater voting accuracy.

For example, someone has a PhD in Physics, may have their votes carry more power as they provide more positive content in system “Physics Experts Only.” Similarly, someone without any education in Physics may have their votes carry less power in the “Physics Experts Only” system.

In some embodiments, the voting power adjustment function I_m adjusts the voting power (or set of powers) p_power for each participant based on their respective voting accuracy to encourage more accurate votes. Further, by adjusting the power according to accuracy, those whose votes have been typically more accurate will have votes that carry more weight.

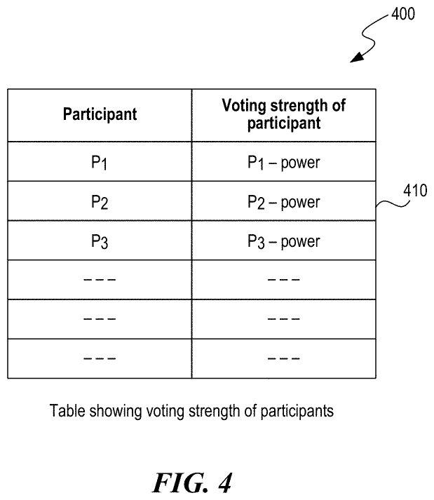

For example, the voting power adjustment function I_m adjusts the voting power of each participant such that if given: (1) two participants p_i and p_j, 2) their accuracies p_accuracy_i and p_accuracy_j, and 3) their voting power (or set of powers) p_power_i and p_power_j, the following property holds true: if (p_accuracy_i>=p_accuracy_j): p_power_i>=p_power_j. In some embodiments, the voting power adjustment function/m can be implemented as a table as shown in FIG. 4.

Element rating module 190 is configured to determine the rating of an element of a system. In some embodiments, the element rating module 190 updates the rating of a given element of a system as soon as a new vote is cast on the element by a participant of the system. In some embodiments, the rating of an element is a function of the vote cast on the element. In some embodiments, the voting power of the participant casting the vote on the element influences the rating of the element. For example, a PhD in Physics who regularly votes on elements accurately in the “Physics Experts Only,” may influence a new elements' rating. For example, this user may immediately provide an element declaring “Proof that the earth is flat” a very lower score and, because this person's voting power is higher, the element will immediately be given a low score.

In other words, in such embodiments, the rating of the element is a function of both the vote cast on the element and the voting power of the participant casting the vote on the element. For example, the voting power of the participants influence votes according to the following property: given that a participant p_i attempts to maximize the final rating of element e, the final rating of the element is e_i, for any two users p_i and p_j: if (p_power_i>=p_power_j): e_i>=e_j.

It should be understood that a user's voting power for a system may evolve with time. In some embodiments, the voting power will be recalculated with time. In some embodiments, prior voting power ratings will be given less weight than current power ratings. For instance, a freshman in Physics may initially have a low score in the “Physics Experts Only” system, but may eventually provide quality votes when they become a graduate student pursuing a PhD.

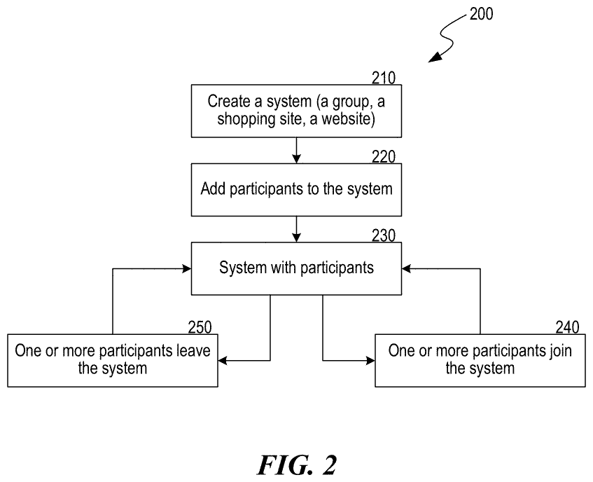

FIG. 2 is a flow chart illustrating a set of operations for an accurate rating system in accordance with some embodiments of the present disclosure. In block 210, a system is created by the system creation module 130.

In block 220, participants are added to the system. Block 230 shows the status of the system at a specific instant and blocks 240 and 250 show participants joining and leaving the system respectively. The system can be a certain grouping, such as a certain topic or subcategory of a posting on a website. For example, a “cat” system can be created, where elements are added to the cat system.

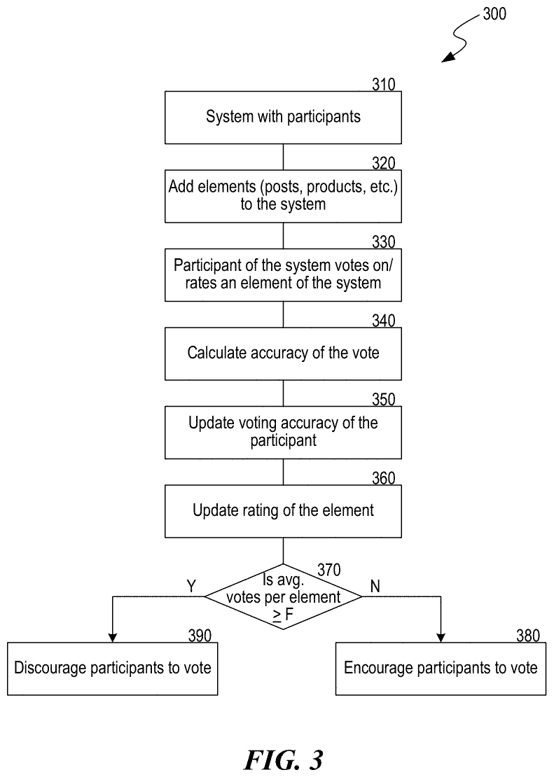

FIG. 3 is a flow chart illustrating a set of operations for an accurate rating system in accordance with some embodiments of the present disclosure. In block 310, a system with participants is created. In block 320, elements are created and added to the system by the element creation module. In block 330, participant of the system votes on an element of the system facilitated a voting module.

In block 340, the vote accuracy determination module determines the accuracy of the vote cast by the participant of the system in block 330. In block 350, the voter accuracy determination module updates the voting accuracy of the participant of the system.

In block 350, the element rating module updates the rating of the element of the system. In block 370, the voting rate maintenance module 160 checks if the average number of votes per element in the system is equal to or greater than a specified value F. In block 380, the voting rate determination module encourages the participants of the system to cast further votes if the average number of votes per element in the system is less than F. On the other hand, in block 390, the voting rate determination module 160 discourages the participants of the system to cast further votes if the average number of votes per element in the system is equal to or greater than F.

FIG. 4 is a table illustrating voting strength of participants of a system for an accurate rating system in accordance with some embodiments of the present disclosure. In some embodiments, the table 400 is a sorted table T_p that contains the participants of the system, and for each participant p_i, a predictive rating value (or set of values) p_rating that represents each participant's overall predictive accuracy or voting strength. In some embodiments, the sorted table T_p may contain a subset of the participants of the system. In some embodiments, the sorted table T_p may represent the leaderboard of the system containing the voting strength of participants of the system. In some embodiments, based on the accuracy of a vote as determined by the vote accuracy determination module, the voter accuracy determination module adjusts p_rating for the respective participant, causing their sorted position in T_p to change. In some embodiments, based on the participant's position in T_p, their voting weight is adjusted by some factor f. In some embodiments, f is set by the moderators of the system.

For example, in system “Physics Experts Only,” certain users who routinely provide accurate votes will be displayed at the top. In an embodiment, each system or group has its own leaderboard, which ranks the accuracy of voters in the community. If a user's voting is more accurate, they will rise on the leaderboard, and gain more power to vote in that group. In an embodiment, moderators are provided and given the power to change scores of elements. This would retroactively count against the leaderboard ranking of anyone who had voted.

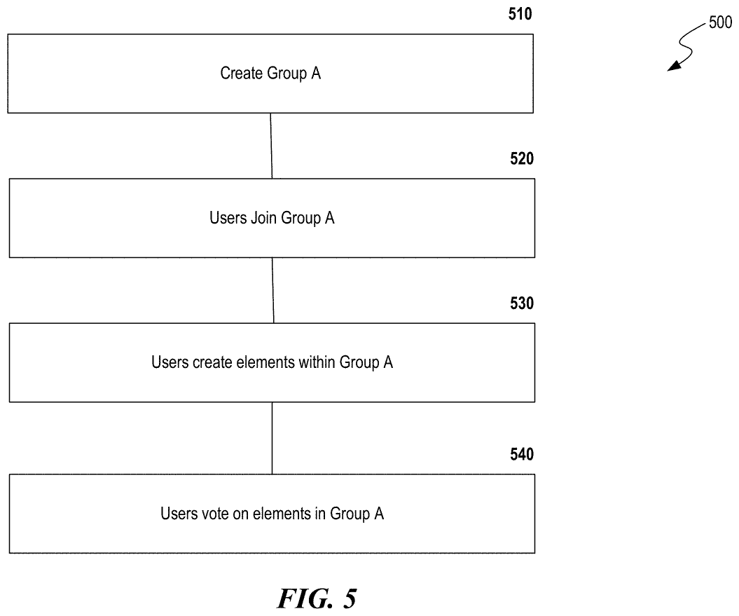

FIG. 5 illustrates an exemplary embodiment according to the disclosures. Group A is created as a system in step 510. Group A is provided as a bulletin or message board, where users can create elements such as postings within Group A. Users join Group A in step 520. One of the users creates an element within Group A in step 530. Users within Group A vote on an added elements in step 540. Users vote based on how popular they believe the element will end up being.

In an embodiment, a particular system can be created with a certain name, set of rules, and owner. In an embodiment, the system can have a unique name. In an embodiment, a user can be restricted to having a number of votes required to post, a standing on the leader board to post, a number of votes required to comment, or a standing on the leader board to comment.

In an embodiment, a user can have an ID, a rank, a percentile, and an associated image. In an embodiment, the leaderboard can be per system, and organized per ID. It can be provided with certain power percentile cutoffs.

Although numerous embodiments were described within context of votes, it should be understood that embodiments of the disclosure are relevant in other contexts. For instance, the disclosure is applicable to determining quality of database elements. Each of those elements can have a weighting, and the weighting is determined in a similar manner as discussed above with respect to the qualitative measure of each input. In an embodiment, the weighting is determined according to a user-provided voting mechanism as described above. In another embodiment, the weighting is determined algorithmically, where a qualitative measure of the weight is determined. For instance, the accuracy of an element A being input according to factor Y, as opposed to an element B being input according to factor Z, can give element A a higher weighting for accuracy in the system.

With embodiments of the disclosure, content can be curated within specifications of the community. The community can beneficially have the most relevant information displayed because it will have the highest scores. In an embodiment, constituents could demonstrate which direction they think that their representatives should vote on certain issues to best reflect the community. Further, in yet another embodiment, users in a tech group could vote on innovations they think are going to be the most beneficial in certain products. In yet another embodiment, members can vote on how effective they think certain measures taken by a governing body will be. In yet another embodiment, community members could vote on what they think the biggest issues facing their community could be and ideas on how to address them. In another embodiment, users in a group based on a certain product could vote on the features they would like to see soonest. In yet another embodiment, the most import news stories in the world, locally, or any scope depending on the rules of the group would be curated allowing people to always be up to date with accurate information.

Embodiments of the present disclosure include various steps and operations, which have been described above. A variety of these steps and operations may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware.

The components described above are meant to exemplify some types of possibilities. In no way should the aforementioned examples limit the scope of the disclosure, as they are only exemplary embodiments.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described, and other implementations, enhancements and variations can be made based on what is described and illustrated in this disclosure. While aspects of the described systems and methods for ratings can be implemented in any number of different computing systems, environments, and/or configurations, embodiments of ratings systems and methods are described in the context of the following exemplary system architecture(s).

What is claimed is:

1. A method for rating and ranking grouped data elements, the method comprising:
receiving, on a processor, a request to create a system, the system relating to a grouping of elements;
recording, via the processor, the system relating to a grouping of elements within a data structure;
receiving, on the processor, a request to add one or more participants to the system relating to a grouping of elements;
adding, via the processor, the one or participants to the data structure;
receiving, on the processor, a request to add one or more elements to the system relating to a grouping of elements from the one or more participants;
receiving, on the processor, one or more ratings corresponding to the one or more elements from the one or more participants, each of the one or more participants having a voting accuracy;
determining, on the processor, the accuracy of the received rating from the one or more participants, the determining based on the one or more participants' voting accuracy;
recording in the data structure, via the processor, the rating corresponding to the one or more elements;
updating in the data structure, via the processor, a voting strength of the one or more participants using the determined accuracy of the vote; and
updating in the data structure, via the processor, the rating of the element using the accuracy of the vote.

2. The method according to claim 1, wherein the system comprises a sub-system and the sub-system further comprises a second set of one or more elements.

3. The method according to claim 1 further comprising: creating a table of participants, the table ranking all of the one or more participants of the system according to a voting score, the voting score being calculated according to the accuracy of votes provided by each participant.

4. The method according to claim 3, wherein the request to add one or more participants is restricted according to the voting score of the participant.

5. The method according to claim 3, wherein the voting score is calculated on a predetermined basis.

6. The method according to claim 1, wherein receiving a request to add one or more participants is provided only after sending an invitation to be added to the system.

7. The method according to claim 1, further comprising calculating an average rate of insertion of elements.

8. The method according to claim 1, wherein the vote is a score of either 0 or 10.

9. The method according to claim 1, wherein the rating of the element is further determined according to a predetermined set of votes.

10. A system for the rating of elements comprising:
a processor and a memory configured to:
receive a request to create a grouping having a topic that relates to a certain concept;
receive a request to add one or more participants to the system;
receive a request to add one or more elements to the system from the one or more participants, the one or more elements each having a corresponding rating;
receive a vote on the one or more elements from the one or more participants;
determine the accuracy of the received vote from the one or more participants;
update a voting strength of the participant using the determined accuracy of the vote; and
update the rating of the element using the accuracy of the vote.

11. The system according to claim 1, wherein the grouping comprises a sub-grouping and the sub-grouping further comprises a second set of one or more elements.

12. The system according to claim 1, wherein the processor and memory are configured to create a table of participants, the table ranking all of the one or more participants of the system according to a voting score, the voting score being calculated according to the accuracy of votes provided by each participant.

13. The system according to claim 12, wherein the request to add one or more participants is restricted according to the voting score of the participant.

14. The system according to claim 12, wherein the voting score is calculated on a predetermined basis.

15. The system according to claim 1, wherein the request to add one or more participants is allowed only after an invitation to be added to the grouping is sent.

16. The system according to claim 1, wherein the processor and memory are further configured to calculate an average rate of insertion of elements.

17. The system according to claim 1, wherein the vote is a score of either 0 or 10.

18. The system according to claim 1, wherein the rating of the element is further determined according to a predetermined set of votes.
